(19) United States
(12) Patent Application Publication
(10) Pub. No.: US 2009/0319914 A1
(43) Pub. Date: Dec. 24, 2009

(54) ASSESSING RELATIONSHIP BETWEEN PARTICIPANTS IN ONLINE COMMUNITY

(75) Inventors: Asta J. Roseway, Bellevue, WA (US); Troy Schauls, Seattle, WA (US); Steven Karl Abrahams, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,859

(22) Filed: Jun. 23, 2008

(51) Int. Cl. G06F 15/16; G06F 3/048

(52) U.S. Cl. 715/753

(57) ABSTRACT

A relationship between participants in an on-line community, such as a social networking site or on-line marketplace, may be determined based on various facts. The nature of the relationship may be represented in a user interface (UI) by a visual element that shows the extent or depth of the relationship. Facets of the relationship may be used to facilitate interaction between participants (e.g., if two participants both like a particular band, then information relevant to the band may be shown as part of the UI when the participants interact with each other). The nature of the relationship may be determined or characterized based on commonality of activities, commonality of interests, the extent to which the participants have interacted with each other in the past, or other facts.

### BACKGROUND

On-line communities (e.g., marketplaces, social networking sites, etc.) generally provide a reputation system through which participants may be assessed against some criteria. For example, on-line marketplaces may allow participants to rate each other's qualities as buyers and sellers (e.g., how fast a buyer pays, how accurately a seller describes an item to be sold, etc.). Gaming communities may provide ratings of a participant's skill as a gamer. Business networking sites may summarize a person's qualifications to participate in various types of businesses.

Information about participants could be made available in an unfiltered form, or could be distilled in some manner. For example, an on-line marketplace might display the unfiltered ratings or narrative reviews that a participant has received. As an alternative to displaying this unfiltered data, information could be distilled from the data. For example, if there are hundreds of numerical ratings of a participant, an average rating could be displayed instead of displaying all of the individual ratings.

While on-line communities may collect data of general interest (e.g., “John pays for his purchases on time”) or basic facts that people might have in common (e.g. “Susan and Fred went to the same college”), these communities generally have not used the data to discover, describe, or foster relationship dynamics between participants. Reputation systems in on-line communities generally focus on “me” not “us”. For example, in a marketplace, reputation systems generally focus on whether a participant has certain qualities that make him or her a good buyer or seller, not on that participant's relationship with other participants.

Some on-line communities may also allow participants to self-identify their relationship with others in the community: e.g., social networking sites may allow participants to identify each other as “friends.” However, such self-assessment systems rely on the participants' self-assessment or self-identification of their relationship with others.

### SUMMARY

Data about participants in an on-line community or marketplace may be analyzed in order to discover relationship dynamics between participants. The relationship dynamics may then be used to drive an interactive experience between participants. The interactive experience may be analogous to a one-to-one reputation system, in which those facets of one participant's on-line persona may be highlighted to another participant, based on the participants' expressed or inferred interests. The existence and/or extent of common interests, behaviors, acquaintances, etc., could be used to “rate” a relationship (e.g., based on the historical or potential depth of that relationship), and this rating could be expressed in some manner such as through a visual metaphor. For example, a tree in various stages of growth could be displayed in order to express the extent of an existing relationship between participants, or to express the potential for a relationship between participants.

For example, participant A may have an interest in the band “U2”, and this interest may have been expressly stated in participant A's profile, or may be inferred from participant A's activities (e.g., purchasing tickets to a U2 concert on-line). If participant B is found to have an interest in the same band, then this fact could highlighted to one or both participants while they interact in an on-line setting. Moreover, facts such as common interests (e.g., bands, hobbies, etc.), common activities (e.g., sharing photos on line, gaming, etc.), the amount of interaction between people (e.g., whether two people chat with each other once a day, once a week, etc.), or any other facts, could be used as a basis to assess the level of relationship between these people. The level of such a relationship could be communicated using a user interface element, such as a graphic representing the tree metaphor mentioned above.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which participants' relationships with each other may be evaluated.

FIG. 2 is a block diagram of an example user interface that may be used as part of an interaction between participants.

FIG. 3 is a flow diagram of an example process in which a relationship between participants may be analyzed.

FIG. 4 is a block diagram of some example sources of facts that may be used as a basis for analysis.

FIG. 5 is a block diagram of various different kinds of facts that could be used as part of a relationship analysis.

FIG. 6 is a block diagram of example components that may be used in connection with implementations of the subject matter described herein.

### DETAILED DESCRIPTION

On-line communities typically offer some type of reputation system. For example, on-line marketplaces allow participants to rate each other's qualities as buyers or sellers. Other types of on-line communities may display ratings of participants based on some criteria—e.g., a participant's level of technical expertise in some area, a participant's skills as a gamer, etc. These reputation systems typically focus on a particular participant, rather than on a relationship between participants.

Some communities allow participants to self-define (or mutually-define) relationships with other participants. For example, participants might identify each other as “friends,” and might even self-characterize the “strength” of the friendship. However, these systems generally do not attempt to identify aspects of a relationship from basic or organic facts collected about participants. The subject matter described herein may be used to assess a relationship between participants. Commonalities between participants may be identified based on facts such as the participants' self-provided profiles, usage patterns, or information extracted from conversations, blogs, or other types of content. Commonalities could be identified to the participants as part of the user interface (UI) that the participants use to interact with the community. Moreover, an assessment of a relationship could result in some sort of “rating” of the relationship. While it may sound somewhat clinical to speak of “rating” one person's relationship with another person, such a rating could benefit participants by helping them to determine which members of a community may be of greatest interest to them. The rating could be provided in the form of a visual metaphor, such as a tree in various stages of growth, representing the depth or extent of the existing or potential relationship between participants (although an assessment of a relationship could be presented in any manner).

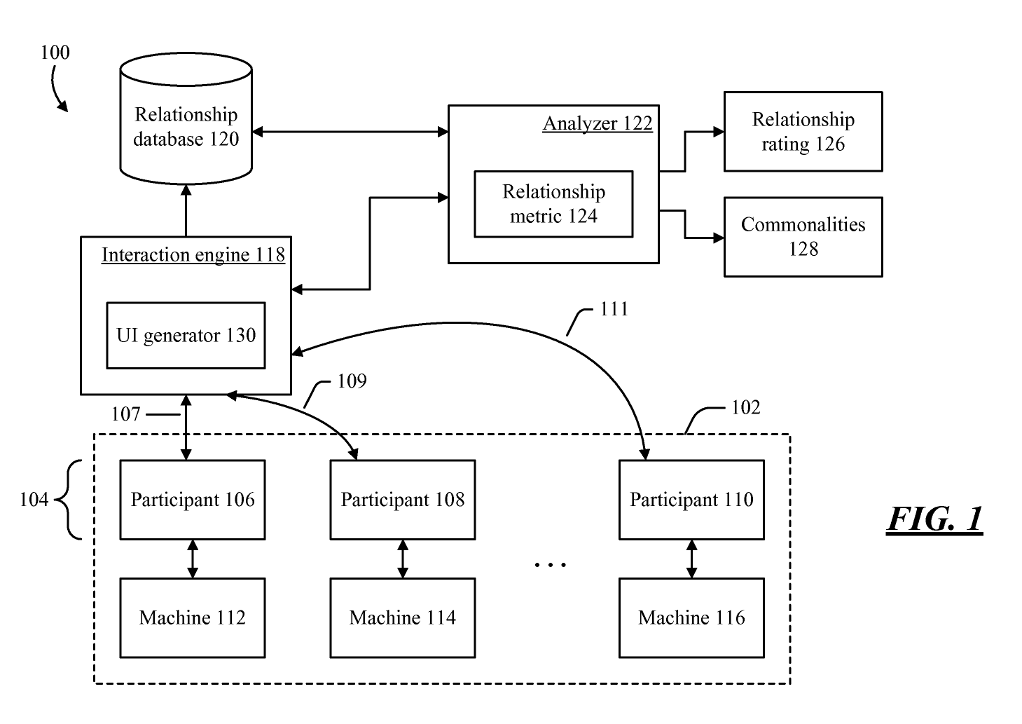

Turning now to the drawings, FIG. 1 shows an example system 100 in which participants' relationships with each other may be evaluated.

In system 100, several participants interact with each other in an on-line community 102. On-line community 102 may be a social networking community, a marketplace, or any other type of community. Participants 104 participate in on-line community 102. FIG. 1 shows three example participants 106, 108, and 110, although there could be any number of participants. In a typical on-line community, there may be tens or hundreds of thousands of participants, or even millions of participants. For example, on-line community 102 could be a marketplace in which many thousands or millions of participants are registered so that they may engage in purchase/sale transactions with each other. As another example, on-line community 102 could be a social networking community, in which thousands or millions of participants are registered in order to converse with each other, exchange photos, or otherwise to participate in various social interactions. While the number of participants in an on-line community may be large, the number of participants in any given interaction may be small. For example, in a marketplace, two participants may engage in a purchase/sale transaction, or a small number of participants may engage in an auction. Or, as another example, in a social networking site, two people may engage in a private conversation, or a few dozen people may engage in a multi-way conversation through a chat room. Additional examples of on-line communities include those organized around technical issues (e.g., software developer communities), politics, medical issues, business networking, etc. While the foregoing discussion provides a few examples of on-line communities, in general an on-line community could be organized around any activity, interest, concept, etc., and could include any number of participants.

Each of participants 104 may participate in on-line community 102 through a machine, such as a desktop computer, handheld computer, wireless telephone, or any other kind of machine that allows participants to interact with each other. In the example of FIG. 1, participants 106, 108, and 110 use machines 112, 114, and 116, respectively, to participate in on-line community. Participation through these machines may involve entering and/or receiving information through the machines. For example, information could be entered through a keyboard, microphone, pointing device, etc., and could be received through a monitor, speaker, etc. Machines 112, 114, and 116 may communicate through a network, such as the Internet, and may include appropriate equipment such as Ethernet adapters, WiFi adapters, etc., to facilitate such communication.

Interaction engine 118 may facilitate interaction among participants. Interaction engine may connect to the participants in some manner (as shown by connections 107, 109, and 111 with between interaction engine 118 and participants 106, 108, and 110, respectively.) Interaction engine 118 could take any form that is appropriate for the particular on-line community 102, and for the manner in which participants 104 interact with each other. For example, if on-line community 102 is implemented as a web site, then interaction engine 118 may comprise a plurality of servers that implement various functions of the web site, and/or software that uses those computers to implement front-end and/or back-end functionality of the web site. The server(s) that implement social networking web sites, on-line marketplaces, etc., are examples of interaction engine 118. Such an interaction engine 118 could perform actions such as providing the web-browser-based interfaces to implement sale/purchase transactions, chat rooms, photo sharing, or any other function. In addition to the web-browser-based interaction described above, on-line community 102 might be implemented through some mechanism other than web browsers. For example, if on-line community 102 is organized around video games, then interaction engine 118 could be one or more servers that interact with gaming clients. Interaction engine 118 could take any form, and could perform any type of action that facilitates interaction among participants 104.

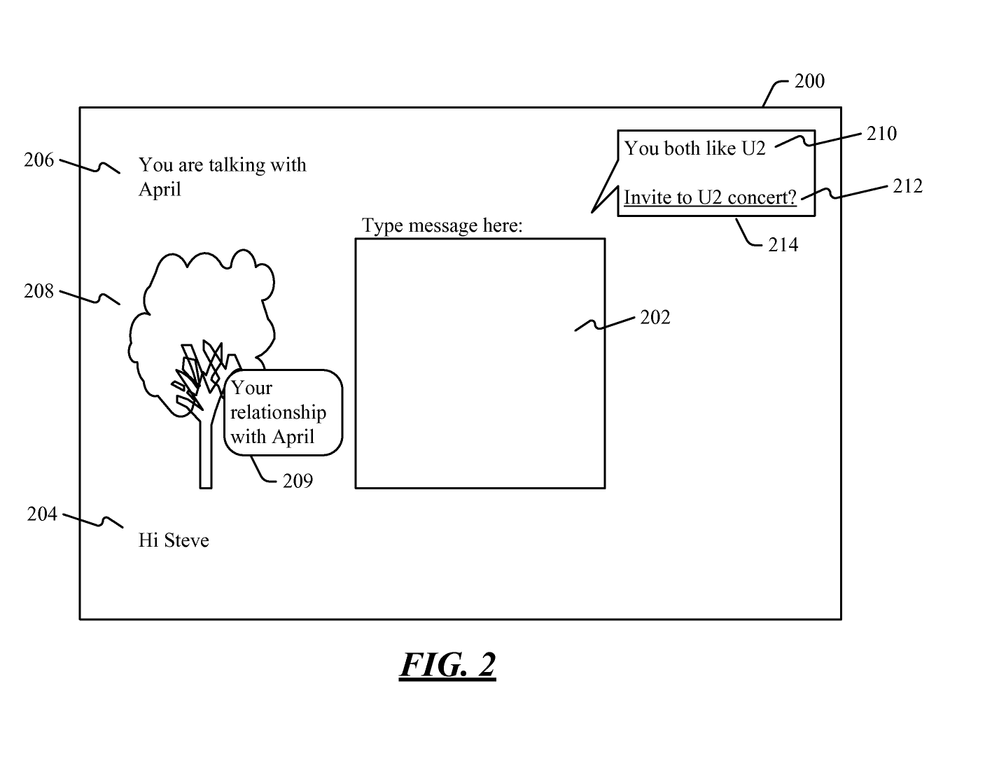

Interaction engine 118 may provide participants 104 with various types of information about relationships among participants. To this end, interaction engine 118 may use various components. For example interaction engine 118 may comprise, or otherwise make use of, relationship database 120, which stores information about relationships between participants 104. For example, the nature of a relationship between two participants (e.g., the relationship's depth, strength, etc.) may be rated on some type of scale, and information about this rating may be stored in relationship database 120. Commonalities between participants also could be stored in relationship database 120. In one example (which is described below in connection with FIG. 2), relationships are described by a tree metaphor, in which the relationship (or potential relationships) are characterized by a tree in various stages of growth based on aspects such as participants' common interests, common activities, levels of interaction, etc. However, relationships could be assessed and described in any other appropriate manner. Relationships among participants may change over time, and the information in relationship database 120 may be updated to reflect these changes.

In order to assess relationships among participants, interaction engine 118 may comprise, or otherwise make use of, analyzer 122. Analyzer 122 takes organic information about participants and identifies aspects of the relationship between pairs of participants 104. Analyzer 122 may store (as indicated by 123) data about these relationship aspects into relationship database 120. Analyzer 122 could identify aspects of a relationship “off-line” by using otherwise idle time to analyze facts about participants 104, or it could analyze relationships among participants “on-demand” (e.g., at the time that the specific participants, whose relationship is to be analyzed, are interacting with each other). The result of the analysis performed by analyzer 122 could take the form of a rating of the relationship between a pair of participants (e.g., the strength of relationship, or potential relationship, between two participants could be rated on a scale such as low-medium-high, or on a numerical scale, or some other type of scale). Or, the analysis could produce various types of specific information about the relationship between two participants (e.g., specific activities or interests that the participants have in common, etc.).

Analyzer 122 may use various tools to analyze the relationships between participants. For example, analyzer 122 may comprise, or otherwise make use of, a relationship metric 124. As mentioned above, part of the analysis that analyzer 122 may perform is to rate the relationship between participants. Relationship metric 124 may be used to make this rating. Relationship metric 124 could take facts into account in any appropriate way in order to arrive at a rating. For example, relationship metric 124 may take into account the number of interests or activities in common between two participants, the number of discernible differences between the participants, a comparison of the participants' own self-provided data (e.g., their ages, geographic locations, educational levels, etc.), or any other type of information.

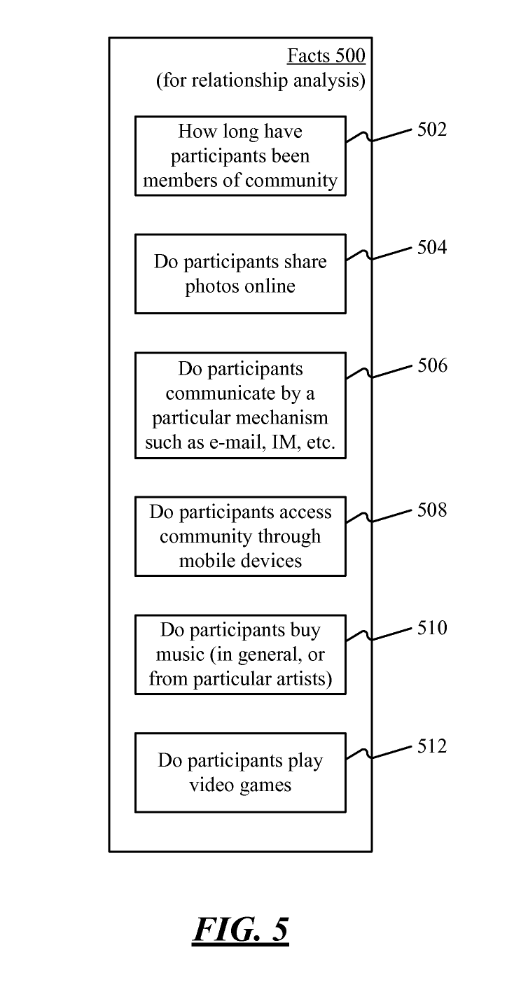

Analyzer 122 may produce various results of its analysis of a relationship. For example, analyzer 122 may produce relationship rating 126. As another example, analyzer may produce an indication of commonalities 128 between two participants. Commonalities 128 could describe anything that two participants have in common, such as the fact that two participants are both interested in music or in a particular musical artist or performer (or in some other type of artist or performer), the fact that two participants like to share photos on-line, the fact that two participants went to the same school, or any other area in that two participants might have in common. (FIG. 5, discussed below, shows some example facts on which a relationship analysis could be based, and some of these facts provide additional examples of commonalities.) Commonalities 128 may exist at any level of detail. For example, commonalities 128 could describe a shared interest in music (coarse level of detail), or a shared interest in a particular musical artist (finer level of detail).

Results produced by analyzer 122 may take various forms. For example, results could exist in the form of raw data to be stored in database 120. As another example, results could be presented as part of a user interface. For example, when two participants are interacting with each other, interaction engine 118 may present, to the participants, a user interface that incorporates aspects of the analysis of these participants' relationship. For example, the user interface could display the rating of the participants' relationship (e.g., using the tree metaphor described above, or using some other type of user interface element). As another example, if commonalities 128 between participants are detected, then these commonalities could be worked into the user interface presented by interaction engine 118. For example, if two participants are both interested in the band “U2”, then the user interface presented by interaction engine 118 could highlight this fact to the participants, and might even inform them of an upcoming concert and/or offer the participants the chance to buy tickets to the concert.

In order to present the results of an analysis to participants in the form of a user interface, interaction engine 118 may comprise, or otherwise make use of, a user interface (UI) generator 130. For example, if relationship rating 126 is to be presented in the form of the tree metaphor mentioned above, then UI generator 130 could generate the tree graphics that constitute a representation of the relationship. Additionally, UI generator 130 could generate UI elements showing commonalities, or other features of a relationship between participants. FIG. 2, described below, shows some examples of UI elements that could be generated by UI generator 130, and of how these UI elements could be integrated into a UI that participants use to interact with each other.

FIG. 2 shows an example user interface 200 that may be used as part of an interaction between participants. UI generator 130 and/or interaction engine 118 (shown in FIG. 1) could be used to generate user interface 200, but user interface 200 could be generated by any appropriate component. User interface 200 may be generated in the form of a web page to be rendered by a web browser, but could also be generated in any appropriate form.

User interface 200, in the example of FIG. 2, takes the form of a page that might be displayed as part of a social networking web site. User interface 200 may be used to allow participants to exchange messages, and thus contains an area 202 in which messages to be sent to other participants could be entered, and/or in which messages received from other participants could be displayed. When user interface 200 is used to interact with a particular participant (“Steve”, in this example), user interface 200 may contain a visual element 204 that greets, or otherwise identifies, the participant. In this example, visual element 204 comprises the textual message “Hi Steve,” although visual element 204 could take any appropriate form.

In the example of FIG. 2, a participant (“Steve”) is holding a conversation with another participant (“April”). User interface 200 thus contains a visual element 206 that identifies April as the participant with whom Steve is talking. In the example of FIG. 2, visual element 206 comprises the textual message “You are talking with April”, although visual element 206 could take any appropriate form.

As mentioned above, a relationship may be rated in some manner. An analyzer may have determined a rating that applies to an existing or potential relationship between the participants “Steve” and “April”. This rating may be displayed, as part of user interface 200, in the form of visual element 208. In the example of FIG. 2, visual element 208 is depicted as a tree. The tree may be a metaphor for the growth, or potential growth, of a relationship between two participants. Thus, the tree may be shown as being larger or smaller, or in different stages of bloom, based on the rating of the participants' relationship with each other (which may reflect the extent of that relationship, its depth, its potential for growth, or any other facet). In the example of FIG. 2, a legend 209 is displayed near the tree, indicating that the tree represents “Your relationship with April.” The tree graphic is one way to convey a rating, although the rating could be conveyed in some other manner, such as a different graphic (whether or not based on some other metaphor), a numeric rating, a star rating, etc.

As a result of the analysis of the relationship between “Steve” and “April,” it may be determined that these two participants have certain commonalities. For example, it may be determined that both participants like the band “U2”. This fact could be determined based on purchases the participants have made, conversations in which they have mentioned the band, self-identification of interests, or from any other data. Thus, some type of information based on the commonality could be provided as part of user interface 200. The information provided could take any form. For example, a message 210 could be rendered informing the participants that they both like “U2”. As another example, a suggestion 212 for one participant to invite another to an upcoming U2 concert could be rendered. The suggestion could be in the form of a link, which, when activated, might offer the opportunity to buy tickets to the concert. (Message 210 and suggestion 212 could be presented in the form of pop-up balloon 214, as shown in FIG. 2, although the manner in which this type of information is rendered could take any form.) Analysis of relationships may be used as a way to facilitate interaction between people, but this example shows that the analysis may also be used as a way to market goods and services (e.g., concert tickets) that may be of interest to people based on their commonalities.

While FIG. 2 shows an example user interface 200 that could be used to as part of a social networking on-line community, a user interface could be generated for any type of on-line community. The content shown in user interface 200 is merely an example, and appropriate content could be generated to support any type of on-line community.

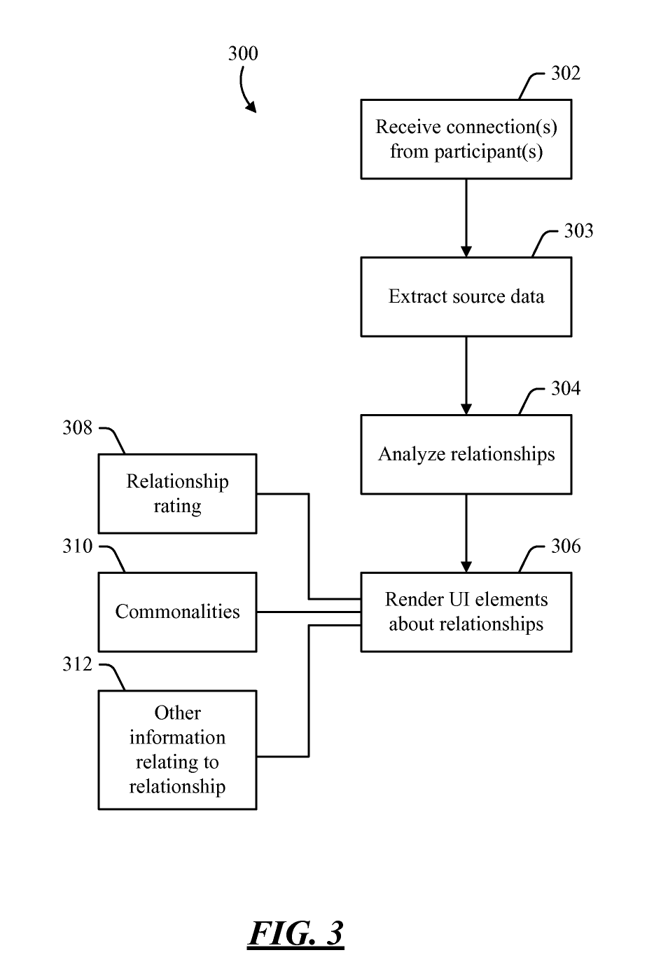

FIG. 3 shows an example process 300 in which a relationship between participants may be analyzed. Process 300 could be performed in the system of FIG. 1 using any of the components shown therein, but could also be performed in any system using any components. Additionally, FIG. 3 shows an example in which stages of a process are carried out in a particular order, as indicated by the lines connecting the blocks, but the various stages shown in FIG. 3 may be performed in any order, or in any combination or sub-combination.

At 302, one or more connections from one or more participants are received. For example, if interaction engine 118 (shown in FIG. 1) is used to facilitate interaction between participants in an on-line community, then the interaction engine may receive connections from one or more participants. If the on-line community is implemented through a web site, then connections could be received when participants visit the web site with their web browsers. As another example, if the on-line community is a community of gamers, then participants could connect to an interaction engine through gaming software. However, the foregoing are examples, and participants could connect, in any manner, to the system that implements the on-line community.

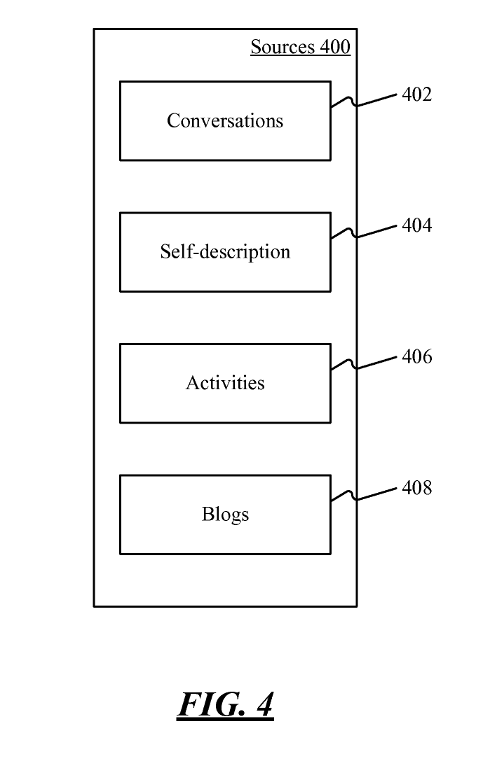

At 303, source data about the participants may be extracted. As discussed below in connection with FIG. 4, source data could be extracted from conversations involving a participant, activities in which the participant is involved, the participant's self-description or profile information, blogs, or any other source.

At 304, the relationship between participants is analyzed. The analysis may occur when the participants interact with each other. Or, the analysis could be performed at some time before the participants interact with each other, so that an analysis of their relationship is ready “on the shelf” in the event that the participants begin to interact with each other. The analysis may generate a rating of the relationship between the participants, a set of commonalities, or any other type of information about the relationship.

At 306, UI elements about the relationship are rendered. The UI elements could include an indication of the relationship rating (block 308) (e.g., the tree metaphor mentioned above, a numerical rating, a star rating, etc.). The UI elements could take any form such as text, images, audio, etc. The UI elements could also include information about commonalities (block 310), or any other information about the relationship (block 312) that was gleaned in the analysis of the relationship.

As noted above in connection with FIG. 1, an analyzer may draw conclusions about a relationship from organic facts about participants in a community. FIG. 4 shows some example sources 400 of these facts, which may be used as a basis for analysis.

One example source of facts about a participant is conversations 402. Data mining and extraction techniques may be used to analyze a participants' on-line conversations with other participants in order to determine a person's interests, activities, likes, dislikes, etc. (A participant might agree to have his or her conversations analyzed in this manner, and, in consideration of privacy concerns that many people have, might be offered the opportunity to opt-out of such analysis.)

Another source of facts about a participant is self-description 404. When a participant registers to be part of an on-line community, the participant may provide various information about himself or herself, such as his or her name, geographic location, age, interests, education, or any other type of information. This information could be used as a basis to analyze relationships among participants, such as the commonalities that exist between two people.

Another source of facts about a participant is activities 406 in which the participant engages. For example, some on-line communities may offer participants the opportunity to engage in certain activities, such as photo sharing, music purchases, blogging, or other activities. The fact that a person participates in these activities may be a basis to analyze a relationship. For example, the fact that two participants like to share photos on-line is an activity that these two participants have in common, and this commonality may be part of their relationship analysis.

Yet another source of facts about a participant is blogs 408. Blogs can be analyzed in a manner similar to conversations, using data mining and extraction techniques. (Moreover, the fact that a person maintains a blog is an activity of that person, and if two people are both bloggers, then this fact may be a commonality of their relationship.)

The foregoing are some example sources of facts that could form the basis of a relationship analysis. However, the facts to be analyzed could come from any source.

While FIG. 4 shows example sources of facts to be analyzed, FIG. 5 shows various different kinds of facts 500 that could be obtained from those sources.

One type of fact that may be used as part of a relationship analysis is how long a given participant has been a member of a community (block 502). People often join communities to try them out. Some people continue with the community while others do not. The fact that a person has been a member of an on-line community for some length of time may suggest that the person has a greater potential to form a relationship with other members of the community. Similarly, the amount that particular participants have actually interacted with each other in the past may be an indication of the existing or potential level of their relationship. For example, the number of times that participants have interacted, or the frequency of their interaction (e.g., daily, weekly, monthly, etc.) could be used to determine the existing or potential level of a relationship.

Another fact that may be used as part of a relationship analysis is whether participants share photos (block 504). In a social networking site, some participants communicate by sharing photos while others do not. The fact that two participants have shown an interest in communicating in this manner may suggest that these two participants have the potential to form a relationship with each other in the community. Similarly, the fact that two participants communicate using the same medium, such as e-mail, instant messaging, etc., may suggest that the two participants have the potential for a relationship within the community (block 506). The fact that two participants communicate using mobile devices (block 508), such as handheld computers or messaging-enabled wireless telephones, may suggest a potential for a relationship, since people who use these devices tend to communicate at a different frequency, and/or with different types of content, than people who communicate mainly with desktop or laptop computers.

Other facts that may be used in a relationship analysis are whether two participants both have an interest in music (block 510) or video games (block 512). The particular choice of musical artists or games may also be considered in a relationship analysis—e.g., the fact that two participants like the same artist or the same game may give them something in common, and thus might increase the relationship rating and/or be considered a commonality between two participants.

FIG. 5 shows some examples of facts that could be considered in a relationship analysis, although any facts could be used.

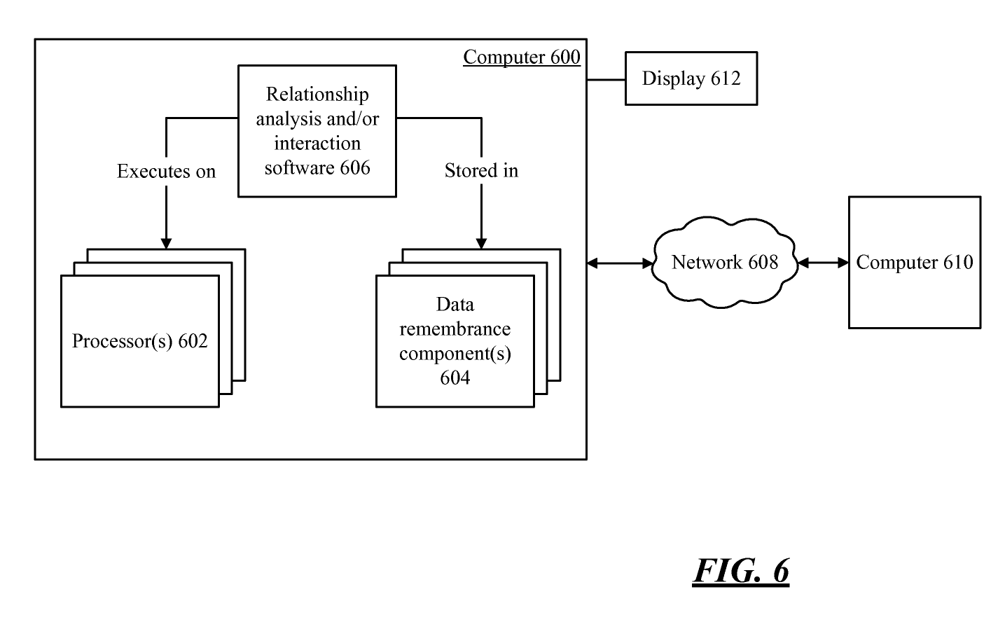

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is relationship analysis and/or interaction software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A personal computer, or server computer, in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as software having instructions to perform one or more acts of a method, where the instructions are stored on one or more computer-readable storage media. The instructions to perform the acts could be stored on one medium, or could be spread out across plural media, so that the instructions might appear collectively on the one or more computer-readable storage media, regardless of whether all of the instructions happen to be on the same medium.

In one example environment, computer 600 may be communicatively connected to one or more other devices through network 608. Computer 610, which may be similar in structure to computer 600, is an example of a device that can be connected to computer 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of facilitating interaction between a first participant and a second participant, the method comprising:
receiving a first connection from said first participant;
receiving a second connection from said second participant;
analyzing a relationship between said first participant and said second participant, based on source data, to produce a result; and
rendering a user interface that comprises an element that is based on said result and that characterizes said relationship between said first participant and said second participant or communicates a commonality between said first participant and said second participant.

2. The method of claim 1, further comprising:
extracting said source data from a conversation involving said first participant or said second participant.

3. The method of claim 1, further comprising:
extracting said source data from a blog maintained by said first participant or said second participant.

4. The method of claim 1, wherein said analyzing is based on whether said first participant and said second participant both share photos, and wherein said rendering comprises:
rendering an indication that said first participant and said second participant both share photos.

5. The method of claim 1, wherein said analyzing is based on whether said first participant and said second participant both participate in video games, and wherein said rendering comprises:
rendering an indication that said first participant and said second participant both participate in video games.

6. The method of claim 1, wherein said analyzing is based on whether said first participant and said second participant have a common interest in an artist or performer, and wherein said rendering comprises:
rendering an indication that said first participant and said second participant both have said common interest in said artist or said performer.

7. The method of claim 1, wherein said element that characterizes said relationship comprises a graphic of a tree, wherein an amount of growth of said tree is based on a rating of said relationship.

8. One or more computer-readable storage media that store executable instructions to perform a method of analyzing relationships among a plurality of participants, the method comprising:
receiving source information about a first one of said plurality of participants and a second one of said plurality of participants;
analyzing said source information to determine a rating of a relationship between said first one of said plurality of participants and said second one of said plurality of participants, and a commonality that exists between said first one of said plurality of participants and said second one of said plurality of participants;
storing said rating and said commonality; and
rendering a user interface that comprises a representation of said rating or said commonality.

9. The one or more computer-readable storage media of claim 8, wherein said source information comprises data that said first one of said participants or said second one of said participants provides about himself or herself.

10. The one or more computer-readable storage media of claim 8, wherein said commonality comprises a fact that said first one of said participants and said second one of said participants both share photos on-line.

11. The one or more computer-readable storage media of claim 8, wherein said analyzing determines whether said first one of said participants and said second one of said participants communicates by a mechanism, and wherein said commonality comprise a fact that said first one of said participants and said second one of said participants both communicate by said mechanism.

12. The one or more computer-readable storage media of claim 8, wherein said analyzing determines said rating based on a level of interaction that has previously occurred between said first one of said participants and said second one of said participants.

13. The one or more computer-readable storage media of claim 8, wherein said user interface comprises said representation of said rating, and wherein said representation comprises a graphic of a tree having a level of growth that is chosen based on said rating.

14. A system for implementing an on-line community, the system comprising:
an interaction engine that receives connections from a plurality of participants and that facilitates an interaction between a first one of said participants and a second one of said participants;
an analyzer that receives source data about said participants and that determines, based on said source data, a commonality between said first one of said participants and said second one of said participants and a rating of a relationship between said first one of said participants and said second one of said participants; and
a user interface generator that renders a user interface that said interaction engine uses to facilitate said interaction, said user interface comprising a first element that represents said rating or a second element that represents said commonality.

15. The system of claim 14, wherein said source data comprises data that said first one of said participants or said second one of said participants provides about himself or herself.

16. The system of claim 14, wherein said analyzer determines, based on said source data, that said first one of said participants and said second one of said participants both participate in an activity, and wherein said commonality comprises said activity.

17. The system of claim 14, wherein said analyzer determines said rating based on one or more facts comprising an amount of time that said first one of said participants or said second one of said participants has been a member of the on-line community.

18. The system of claim 14, wherein said analyzer determines said rating or existence of said commonality based on whether said first one of said participants and said second one of said participants both participate in the on-line community through a mobile communication device.

19. The system of claim 14, wherein said analyzer determines said rating or existence of said commonality based on whether said first one of said participants and said second one of said participants both have an interest in a particular musical artist.

20. The system of claim 14, wherein said first element of said user interface comprises a representation of said rating, and wherein said representation comprises a graphic of a tree having a level of growth that is chosen based on said rating.
